(19) United States
(12) Patent Application Publication
(10) Pub. No.: US 2005/0051150 A1
(43) Pub. Date: Mar. 10, 2005

(54) Application improvement for portable built-in barbecue

(76) Inventor: Daniel Scheer Viapiana, Caxias do Sul (BR)

Correspondence Address: MERCHANT & GOULD PC, P.O. BOX 2903, MINNEAPOLIS, MN, 55402-0903, US

(21) Appl. No.: 10/658,831

(22) Filed: Sep. 8, 2003

(51) Int. Cl. A47J 37/00

(52) U.S. Cl. 126/41 B; 126/41 R

(57) ABSTRACT

A portable built-in barbecue unit that includes a rotating spits system, powered by continuous or alternating current, allowing a homogeneous roast. The unit is lighter and compact when compared to previous units. This unit hold all the necessary equipment for barbecue with no loose pieces, which makes its transport easier. The unit is more practical and efficient when compared to previous units. This portable built-in barbecue lasts longer when compared to the units available in the market due to its corrosion-resistance feature which helps protect the unit against oxidation. In short, it is highly safe and capable of homogeneously spreading heat, making the best use of charcoal.

### BACKGROUND OF THE INVENTION

1. Field of the Invention

This descriptive report presents the utility model patent of the application improvement for portable rotating built-in barbecue. The barbecue is intended to be best used for broiling and roasting meat and can be used anywhere the user wishes to. The equipment is manufactured in various sizes and shapes, preferably in aluminum and wood, but can also be made of other appropriate synthetic or natural materials.

2. Description of the Prior Art

The background of the invention for similar machines has been highly developed and presents a large choice of portable barbecue unit. Nevertheless, some observations should be made concerning such units.

The portable barbecue unit available in the market are traditionally made from iron. They consist of a base where the charcoal compartment is set and where the spits are supported.

In spite of fulfilling purpose, these units face a series of disadvantages. They are difficult to be transported inside vehicles because they are too big and heavy to be placed inside the trunk.

Another inconvenient of the available barbecue models lies in the necessity of human intervention when handling the spits during the roasting process, what results in an irregular and not homogeneous bake of the food.

### SUMMARY OF THE INVENTION

The great advantage of this improvement application for portable built-in barbecue lies in being a rotating spits system, powered by continuous or alternating current, allowing a homogeneous roast. The fact of being a lighter and compact model when compared to those in the background of invention also stands as a advantage. This unit hold all the necessary equipment for barbecue with no loose pieces whatsoever, which makes its transport easier. As a result, the equipment is more practical and efficient when compared to those in the background of invention. In addition to the advantages above mentioned, this portable built-in barbecue lasts longer when compared to the units available in the market due to its corrosion-resistance feature which helps protect the unit against oxidation. In short, it is a highly safe equipment capable of homogeneously spreading heat, making the best use of charcoal.

Therefore, this system is a novelty, due to all the new innovations introduced in the device, all shown up above.

In order to have improvement applications for portable built-in barbecue clearly understood and issued by any expert in the area, here follows a clear, concise and objective description of the equipment. We shall have as a basis a set of drawing concernin this utility application. The drawings are intended to be presented as simple references and not meant to limit the patent possibilities. Therefore the drawings simply aim at helping illustrate the application features. However, the present utility shall not be limited to the way it is here present. Other models, provided that guarantee the same functional distinctive features of the unit, may be considered.

### BRIEF DESCRIPTION OF THE DRAWINGS

This drawing presents refereded numbers where:

FIG. 1 presents an over view of the closed barbecue unit.

FIG. 2 presents an inferior view of the closed barbecue unit.

FIG. 3 presents a front view of the closed barbecue unit.

FIG. 4 presents a side view of the closed barbecue unit.

FIG. 5 presents a front view of the assembled unit (open lid).

FIG. 6 presents a side view of the assembled unit (open lid).

FIG. 7 presents an over view of the assembled unit (open lid).

FIG. 8 presents an inferior view of the assembled unit (open lid).

FIG. 9 presents a detailed view of the barbecue lid (2), where the spits are positioned.

FIG. 10 presents a detailed view of the engine-gears system, responsible for the rotative movement of the spits.

FIG. 11 presents an inferior perspective view of the closed barbecue unit.

FIG. 12 presents an over perspective view of the closed barbecue unit.

FIG. 13 presents a perspective view of the assembled unit (open lid).

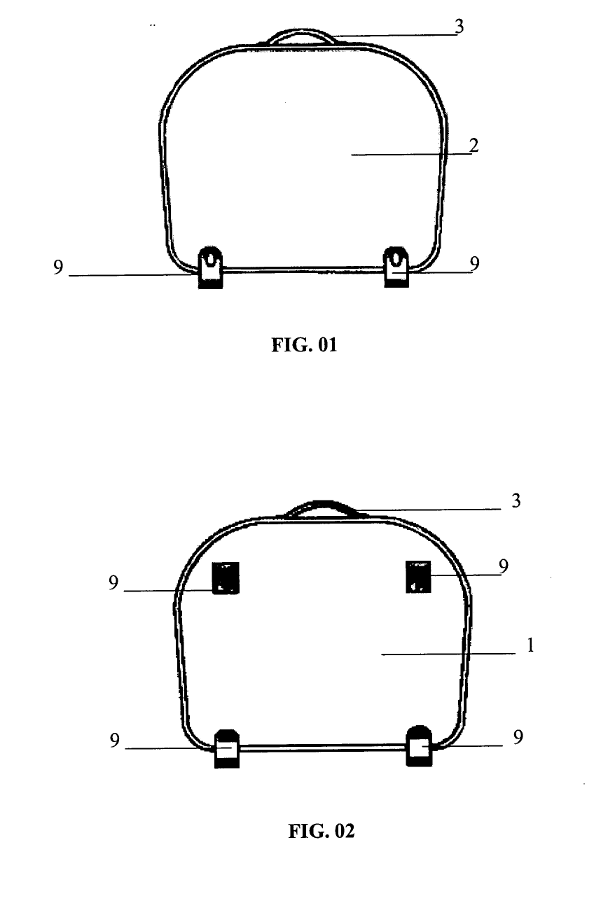

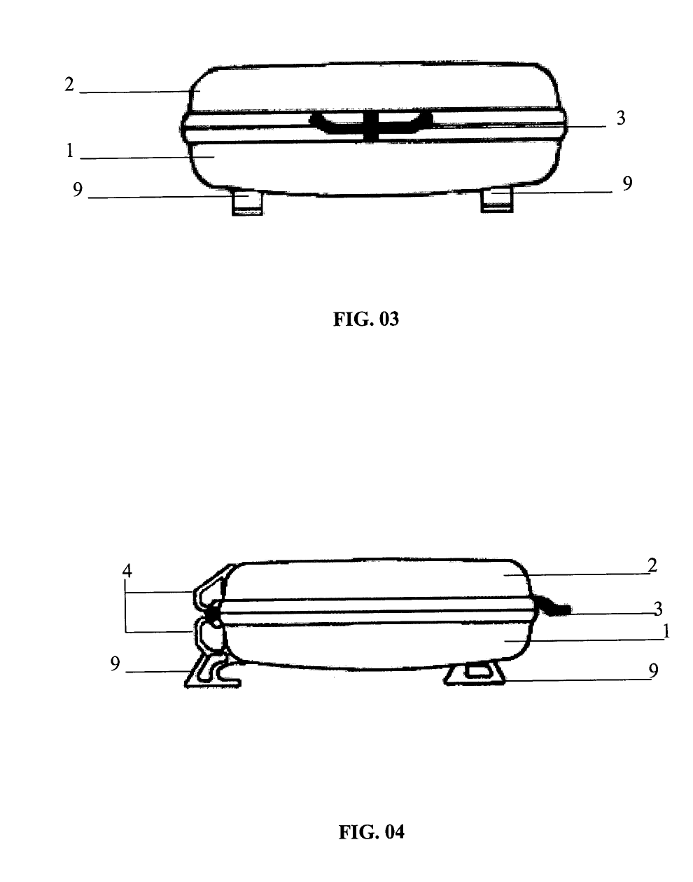

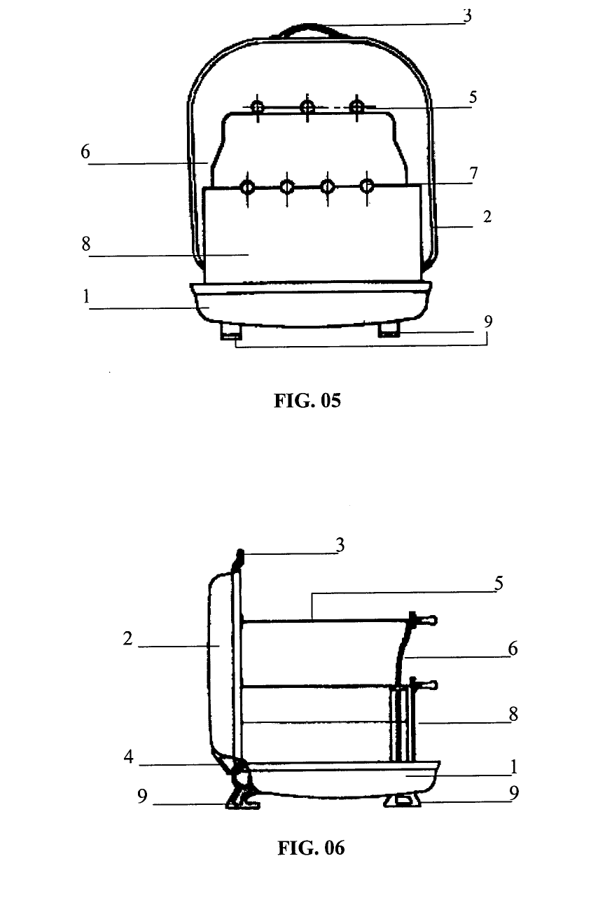

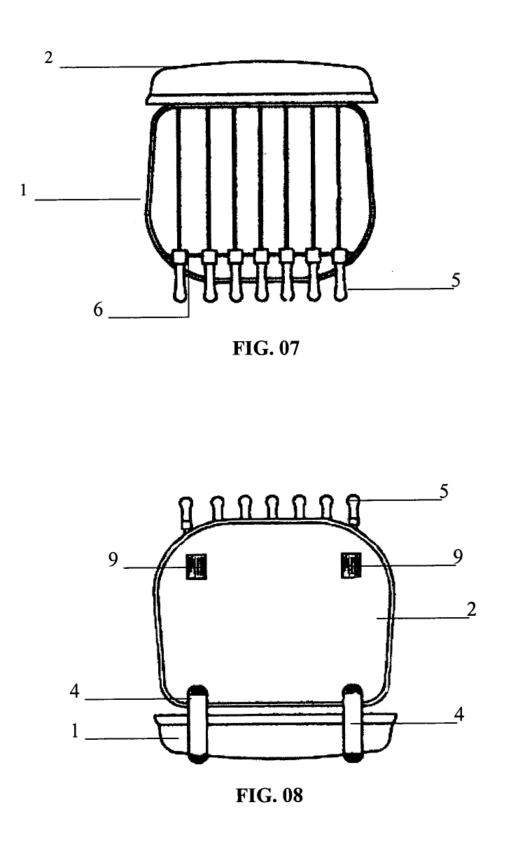

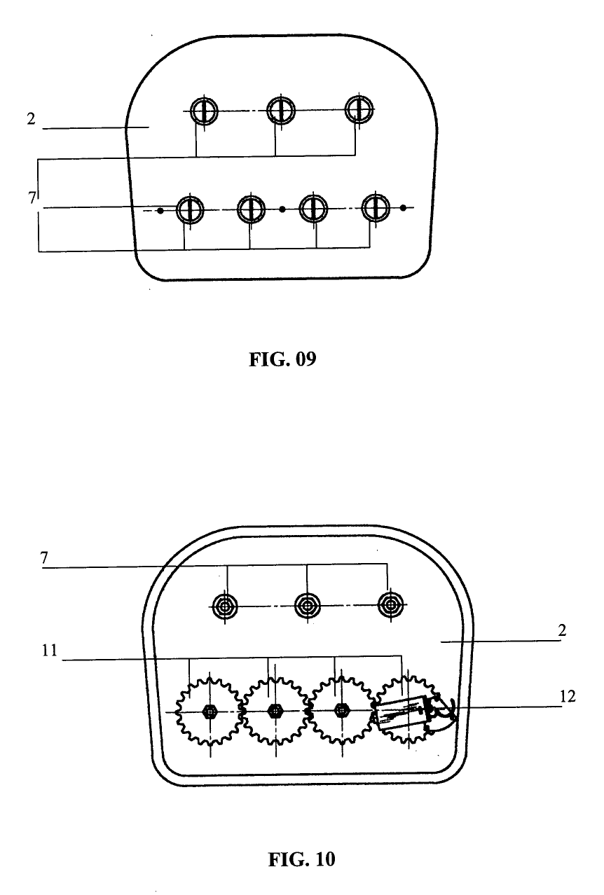

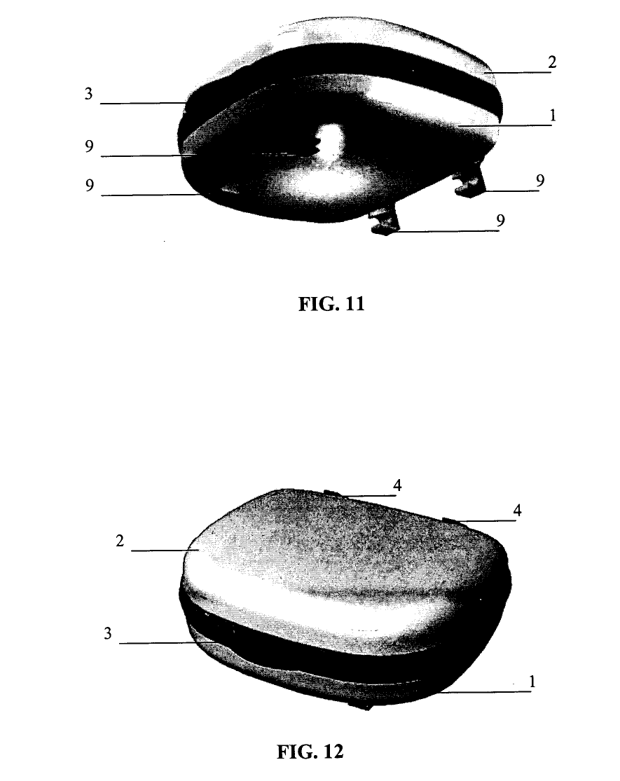

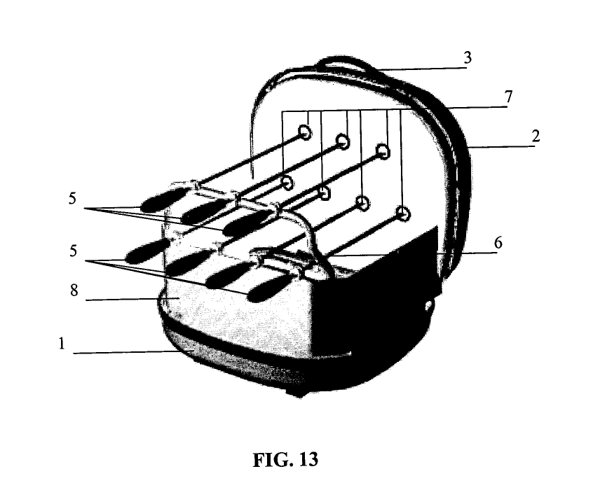

### DETAILED DESCRIPTION OF THE PREFERRED EMBODIMENT

The equipment consists of an aluminum base (1), which is used for keeping the charcoal to be lit, and an aluminum lid (2), which contains a pierced board (7) inside it. This board is used for supporting the spits (5), which are arranged one over the other so as to make up the barbecue case. On the back of the barbecue, there is a stop-device system (4), which prevents the spit supporting board (2) from opening over a 90°-degree angle. The lid (2) can be maintained at this angle or not.

The equipment also contains a set of detachable spits (5), a spit supporting base (6) and a protecting board (8) for the charcoal and/or fire compartment, which prevents wind from stopping heat to spread.

In the lid's interior, where the spits (5) are mortised, is found a 12 Volt electric engine (12) connected to four gears (11). This mechanism gives the spits (5) its rotating movement and the electric engine is also connected to a transformer, which accompanies the equipment with the function of adjusting the incoming voltage. By this means, the portable rotating barbecue can be switched on in any source of electrical power available, such as a truck, car or motorbike battery. It can also be turned on directly in the electric network or a generator. The rotating spits movement allows the food to be homogeneously roasted.

The unit consist of a supporting base (1) attached to a lid (2) by the means of hinges. A handle (3) is positioned in the front part and a stop-device system (4) on the back of the unit, which makes the lid (2) stop at a 90°-degree—inclination angle in relation to the supporting base (1) whenever the unit is opened. Thus, the unit consists of a case with a specialoponen device. Inside the unit, there is a set os detachable spits (5) which rest on a metal piece (6) when the equipment is assembled. The spits are inserted in the holes (7) located in the internal part of the lid (2). The equipment also contains a fire shield (8) which is supported by the internal part of the supporting base (1), and a set of supporting pieces (9) attached by the lower part of the supporting base (1).

In the lid's interior (2) is located the engine-gears system, responsible for the rotating spits movement. This set of equipment is formed by the engine (10), powered by an alternating or continuous current, connected to a transformer used to adjust the incoming voltage.

By this means, the improvement applied to the portable barbecue are guaranteed by the unprecedented technical and functional characteristics, as it can be verified in the illustrations attached and comprehended on the present descriptive report, therefore, earning the legal protection pleaded.

1. A barbecue unit comprising:
a base;
a cover pivotally connected to the base and pivotable relative to the base between a closed position and an open position;
a plurality of spits rotatably mountable on the cover when the cover is at the open position; and
a drive mechanism disposed within the cover, said drive mechanism including a plurality of gears drivingly engageable with the spits and an engine in driving engagement with the gears.

2. A portable barbecue unit, comprising:
a base;
a cover pivotally connected to the base and pivotable relative to the base between a closed position and an open position; and
at least two rows of spits rotatably supported on the base and cover when the cover is at the open position.
